(19) United States
(12) Patent Application Publication
(10) Pub. No.: US 2002/0060557 A1
(43) Pub. Date: May 23, 2002

(54) Bidirectional voltage converter

(76) Inventor: Jan Reinder De Boer, Drachten (NL)

Correspondence Address: Philips Electronics North America Corporation, 580 White Plains Road, Tarrytown, NY, 10591, US

(21) Appl. No.: 09/893,127

(22) Filed: Jun. 27, 2001

(30) Foreign Application Priority Data
Jun. 28, 2000 (EP) 00202236.6

(51) Int. Cl. G05F 1/40

(52) U.S. Cl. 323/282

(57) ABSTRACT

An up-down converter for converting, in the down mode, a supply voltage (Vcc) into a charging voltage for charging a battery (6) and for converting, in the up mode, a battery voltage into a drive voltage for an electrically driven device (4), the battery voltage being considerably lower than the drive voltage.

The invention relates to a voltage converter circuit for converting, in a first mode of operation, a voltage supplied by a power supply source into a charging voltage for charging a storage battery. Such a voltage converter circuit is used, for example, in a shaver having a rechargeable battery.

In electrical apparatuses, such as shavers, the power supply source is usually energized via the electric mains. However, the apparatuses have a complicated design because separate electrical circuits are included for the supply voltage provided by the battery and for the supply voltage provided by the power source. As a result of this, the performance of the apparatus may differ in the different modes of operation, i.e. in the mode in which the supply voltage is supplied by the battery or in the mode in which the supply voltage is supplied by the power supply source. Particularly, the electronic circuits in such an apparatus are implemented in such a manner that during use of the power supply source the battery can be drained or charged depending on its degree of charging, as a result of which an indication of the battery charge on a display is often unreliable. The apparatuses are often tailor-made, i.e. the electrical circuits are configured separately depending on the type of motor and the battery type. In known arrangements the circuits are often not capable of supplying a constant motor voltage for a motor, as a result of which the speed of the motor may vary in an undesirable manner. A further disadvantage is that the customary design often does not allow the use of the apparatus in the mains-powered mode if the storage cell is absent or even if it is fully discharged. Finally, present-day designs often exhibit a comparatively large power loss because the currents flow through a comparatively large loop.

It is an object of the invention to eliminate these disadvantages and to provide an improved voltage converter circuit by means of which an improved performance of shavers can be achieved an which, in addition, is more versatile than the architectures that are customary until now. This object is achieved by means of a voltage converter circuit of the type defined in the opening paragraph in which the voltage converter circuit is adapted to also convert, in a second mode of operation, the voltage from a storage battery into a supply voltage for powering an electrical device. This results in a voltage converter circuit which, for example in a shaver, can energize the motor with voltage from the power supply source or with voltage from the storage battery, enabling the same drive and control circuits to be used for both modes of operation. The battery voltage can be substantially lower than the voltage from the power supply source. Such a design enables the same configuration to be used in several designs, particularly in designs using different numbers of storage cells. The operation of the circuit remains optimal, even if the storage cells are of a comparatively poor quality or have already been discharged for a considerable part. Another advantage is then that the power losses are limited in that the currents flow through a comparatively small loop.

In one embodiment the voltage converter comprises a first loop and a second loop, which first loop includes a current storage element, such as an electrical coil, in series with a storage battery, and which second loop includes a charge storage element, such as a capacitance, as well as two switching elements controlled by a control unit, one switching element being shared by the two loops.

The invention also relates to an electrical device which can be powered by means of an external power supply source or by a supply voltage supplied by a storage battery, including a voltage converter circuit having the aforementioned characteristic features. The structure has the advantage that the electrical device can be powered directly by the external power supply source, without the need to include an storage cell in the voltage converter circuit. The external power supply source may deliver a supply voltage formed by a direct voltage obtained by stepping down and rectifying the mains voltage. If the battery voltage has an adequate level and the voltage from the external power supply source is absent, the voltage converter circuit can power the device in the second mode of operation, referred to as the UP mode hereinafter and, if the voltage from the external power supply source is available and the device is in the off state, the voltage converter circuit can charge the storage battery in the first mode of operation, referred to as the DOWN mode hereinafter.

Preferably, the electrical device further includes a control unit which controls the voltage converter circuit, the control unit being active in a STANDBY mode if the device is in the off state and the battery voltage is adequate. The control unit can be powered by the external power supply source or, if this source is absent and the battery voltage is adequate, by the voltage converter circuit, which is active in the UP mode. Preferably, the power supply of the control unit in the STANDBY mode is based on a low frequency burst mode. If the supply voltage is absent and the battery voltage is inadequate the control unit and the voltage converter circuit can be turned off. However, in normal use this occurs hardly ever because the quiescent current of the control unit is very small. The device in accordance with the invention is therefore suitable for retaining data for a comparatively long time by means of only one storage cell. When the voltage converter circuit charges the battery in the DOWN mode the control unit can measure the charging current and can control the voltage converter circuit on the basis of the charging current thus measured. In the DOWN mode the voltage converter circuit can charge the battery on the basis of fast charging and, after turn-off, on the basis of trickle charging. Such a turn-off may be determined by a given temperature rise but it may alternatively be determined by expiry of a given time or the shape of the battery voltage characteristic. In the DOWN mode the voltage converter circuit can charge the battery via synchronous rectification by controlling the peak current values. The device may further include a motor whose motor drive voltage is supplied by an external power supply source or, if this source is absent and the battery voltage is adequate, this drive voltage is supplied by the voltage converter circuit when this operates in the UP mode. Preferably, the drive voltage for the motor is controlled by the control unit by means of pulse-width modulation. If the drive voltage is supplied by the voltage converter circuit no pulse-width modulation is required. The pulse width duty cycle can then be 100% because the voltage can be adapted accurately to the voltage required for the d.c. motor. This reduces transmission losses.

Preferably, the electric motor is driven on the basis of a voltage measured in the motor because the voltage dictates the speed of the motor. During starting of the motor a drive voltage turn-off circuit may be active, which temporarily turns off the motor in the case of an excessive load, as a result of which the motor starts more slowly. The supply voltage and the mains voltage may then be electrically isolated. The invention further relates to a shaver in accordance with one of the aspects described hereinbefore.

The invention will be described in more detail with reference to the drawing, in which:

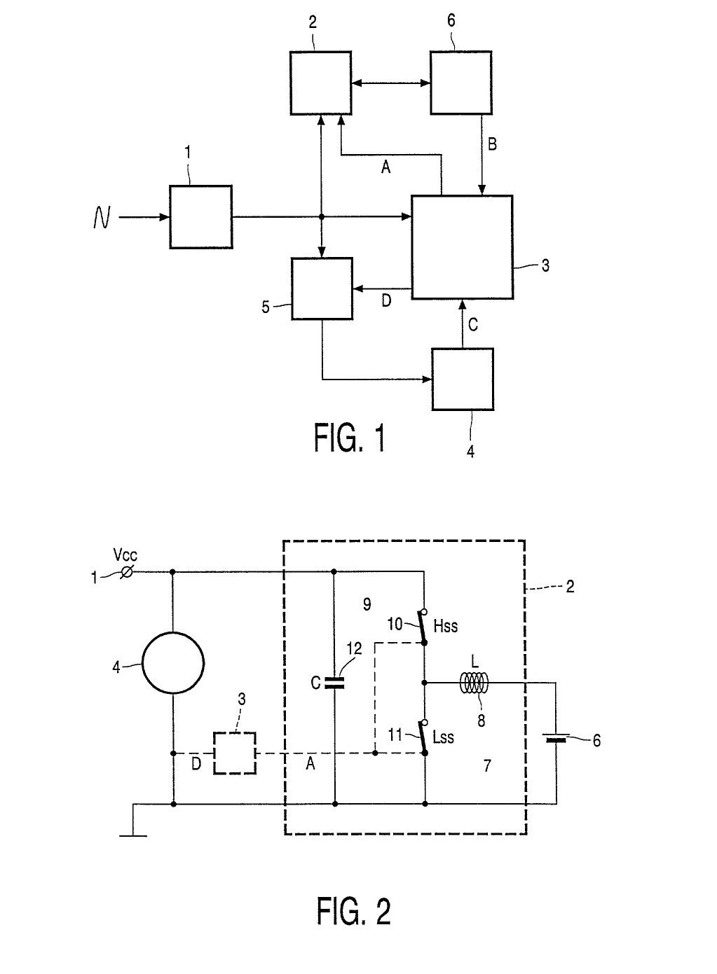

FIG. 1 diagrammatically shows a structure for a shaver, and

FIG. 2 diagrammatically shows some components of an electrical circuit having the structure as shown in FIG. 1.

In FIG. 1 the reference numeral 1 denotes a power supply source which converts the alternating voltage from the power mains into a supply voltage. The supply voltage is a direct voltage obtained by stepping down and rectifying the mains voltage. The supply voltage and the mains voltage are electrically isolated in the power supply source 1, which adds to the safety during use of the shaver.

The direct voltage ranges between 6 V and 30 V and is used as the supply voltage for a voltage converter 2, for a control unit 3 and for a d.c. motor 4. The control unit 3 can be, for example, a microcontroller (a digital microcircuit) or an ASIC (a microcircuit that also includes analog components). The motor 4 is driven with the aid of pulse-width modulation. This pulse-width modulation is effected by the switching circuit 5, which for example comprises a power transistor and a diode, which are controlled by the control unit 3 via a control line D. The control unit 3 alternately turns on the transistor of the switching circuit 5. Thus, the electric motor 4 is connected to the direct voltage with a variable switching period (duty cycle). The resulting effective voltage is applied to the motor 4. The voltage in the electric motor 4 is measured via a control line C, the pulse-width modulation being controlled on the basis of this measurement. During starting of the motor a drive voltage turn-off circuit is active.

In the circuit structure the control unit 3 acts as a central control unit for controlling the voltage converter 2 and the switching circuit 5. The control unit is powered by the supply voltage or, if the supply voltage is absent and the battery voltage is adequate, by the voltage converter circuit when this circuit operates in the UP mode.

The control unit operates in a STANDBY mode if the device is in the off state and the battery voltage is adequate. In the STANDBY mode the control unit 3 is powered on the basis of a low frequency burst. Depending on the design used for the control unit 3, this limits the quiescent current to a few tens of microamperes at the most, as a result of which the battery is loaded to a comparatively small extent and data can be preserved for many tens of days. If the supply voltage is absent and the battery voltage is inadequate, the entire system is turned off.

The voltage converter 2 includes a voltage converter circuit in accordance with the invention. If the battery voltage of a storage battery 6 has an adequate level and the supply voltage of the power supply source 1 is absent the voltage converter circuit 2 is set to the UP mode via the control line A when the motor 4 is switched on. If the supply voltage is present and the device is turned off the voltage converter circuit is set to the DOWN mode via the control line A.

In the DOWN mode the voltage converter 2 converts the supply voltage from the power supply source 1 into a charging voltage for charging a storage battery 6. The supply voltage is then stepped down and behaves as a current source. The voltage converter is controlled by the control unit 3 via the control line A. Thus, the mode (UP or DOWN) of the voltage converter is determined by the control unit 3 via the control line A. The charging current is then measured by the control unit via the control line B. The voltage converter circuit 2 is controlled on the basis of the charging current thus measured. Controlling is effected in such a manner that the storage battery is charged with a high power, as a result of which the storage battery rapidly reaches the desired voltage level (i.e. rapid charging). When the storage battery is full the temperature increases, as a result of which the control unit 3 interrupts the charging current. Subsequently, charging is based on the application of comparatively large charging currents with a duty cycle. Charging can be effected via synchronous rectification, the period of charging and discharging of a coil which serves for energy storage being controlled on the basis of the peak current values (referred to as Current Mode Control). These variants depend on the envisaged use and do not limit the scope of the invention. It is conceivable, for example, that controlling is based on a given duty cycle, i.e. a non-continuous current conduction.

In the UP mode the battery voltage is converted into a drive voltage for driving the motor 4. The battery voltage is then substantially lower than the drive voltage. In practice, the value of the battery voltage varies between 0.9 and 4.2 V and the value of the drive voltage between 6 and 7 V. This makes it possible to use the same structure in the case of a plurality of comparatively weak storage cells 6.

The operation of some components of an electrical circuit as shown in FIG. 1 will now be described in more detail with reference to FIG. 2, like parts bearing the same reference numerals.

The voltage converter 2 is made up of a comparatively small loop 7 and a large loop 9. The small loop 7 includes a coil 8 in series with a storage cell 6. The small loop 7 connects to the larger loop 9, which includes two transistor switches Hss 10 and Lss 11 in such a manner that one switch Lss 11 is shared by both loops. The large loop 9 further includes a capacitor 12. The capacitor 12 is charged either by an external power supply or by a current from the coil 8. The switches Hss and Lss (10, 11) are controlled by a central integrated circuit 3 via the control line A, which integrated circuit also carries out the pulse-width modulation for the electric motor 19 via the control line D (the aforementioned control lines B and C are not shown).

The operation of the circuit in the DOWN mode, i.e. the charging mode, which consists of a primary and a secondary mode, is as follows. The small loop 7 receives voltage from the electrical power supply source Vcc, in that the switch Hss 10 is closed and the switch Lss 11 is opened. A charging current, which is equal to the current through the coil 8, flows through the storage cell 6. In this primary mode DOWN mode the current increases substantially linearly as a function of time, in accordance with the formula

$$\frac{ⅆ I}{ⅆ t} = \frac{V}{L} \qquad ( 1 )$$

where L is the impedance of the coil, V the voltage across the coil and I current through the coil.

The integrated circuit 3 can control the current by means of Current Mode Control; the current then oscillates between peak values controlled by the circuit 3. As a result of this, the switch Hss 10 is opened and the switch Lss 11 is closed at a given instant. The charging current from the coil 8 in the small loop 7 is then applied to the storage cell 6 in a secondary DOWN mode. By alternating the primary and the secondary DOWN mode an average charging current I_{load} is applied to the storage cell 6.

If the circuit is in the UP mode, i.e. the mode in which the storage cell 6 operates as a power supply, its operation is similar to that in the DOWN mode as described. The UP mode also consists of a primary and a secondary mode. When the voltage in the storage cell 6 is adequate the current in the coil 8 will be reversed after some time and will flow through the coil 8 in a direction opposite to that in the DOWN mode. From this instant the energy E from the storage battery 6 will be stored in the coil 8 in accordance with the formula

E=½L I² (2)

A part of this energy (in the absence of the external power supply) becomes available in the secondary UP mode when Hss 10 is closed and Lss 11 is opened. In the secondary mode current stored in the coil 8 flows into the large loop 9 and into the capacitance 12, as a result of which a voltage is built up in accordance with the formula

V=1/C˜Idt (3)

where C is the impedance of the capacitance 12. By alternately opening and closing the switches 10, 11, which results in alternation of the primary and the secondary UP mode, an average power supply current I_{voed} is applied to the capacitor 12. The current source characteristic of the circuit thus turns into a flattened voltage source characteristic.

When the voltage converter 2 is in a primary DOWN mode, this mode should be interrupted in order to change over from the DOWN mode (charging mode) to the UP mode (power supply mode), by opening the switch Hss 10 and closing the switch Lss 1 1; when the voltage converter 2 is in the secondary DOWN mode it can remain in this mode, the current being reversed automatically, thereby causing the voltage converter 2 to assume the primary UP mode.

Conversely, when the voltage converter 2 is in a primary UP mode, this mode should be interrupted in order to change over from the UP mode to the DOWN mode, by opening the switch Hss 11 and closing the switch Lss 10; when the voltage converter 2 is in the secondary DOWN mode it can remain in this mode, the current being reversed automatically, thereby causing the voltage converter 2 to assume the primary DOWN mode.

The voltage built up in the capacitance 12 is applied to the electric d.c. motor 4, which is driven by a central integrated circuit 3 using pulse-width modulation. The duty cycle of the pulse width can be 100% in the UP mode because the voltage can be adapted accurately to the voltage required for the d.c. motor. This reduces transmission losses.

In the STANDBY mode the voltage converter operates in the UP mode. The power supply of the control unit is then based on a low frequency burst mode, voltage being applied from the voltage converter to the control unit.

The characteristic features and the advantages of the invention are apparent from the arrangement described above, particularly the feature that by actuation of the switches the voltage converter circuit 2 is also adapted to power the electrical device 4. Furthermore, power losses due to comparatively large currents occur only in the short loop 7, which results in a higher charging efficiency. It is evident that the absence of a storage cell 6 in the described arrangement does not have any effect on the drive of the electric motor 4 by the external power supply 1.

Although the embodiment described by way of example with reference to the Figures relates to a shaver including such a voltage converter, it will be evident that the invention may likewise be applied to other types of electrical devices such as numerous domestic appliances or consumer products.

1. A voltage converter circuit for converting, in a first mode of operation, a voltage supplied by a power supply source into a charging voltage for charging a storage battery, characterized in that the voltage converter circuit is adapted to also convert, in a second mode of operation, the voltage from a storage battery into a supply voltage for powering an electrical device.

2. A voltage converter circuit as claimed in claim 1, characterized in that it comprises a first loop and a second loop, which first loop includes a current storage element, such as an electrical coil, in series with a storage battery, and which second loop includes a charge storage element, such as a capacitance, as well as two switching elements controlled by a control unit, one switching element being shared by the two loops.

3. An electrical device that can be powered by means of a voltage supplied by an external power supply source and by means of a supply voltage supplied by a storage battery, characterized by a voltage converter circuit as claimed in any one of the claims 1-3.

4. An electrical device as claimed in claim 3, characterized in that if the battery voltage has an adequate level and the voltage from the external power supply source is absent, the voltage converter circuit powers the device in the second mode of operation and, if the supply voltage is available and the device is in the off state, the voltage converter circuit charges the storage battery in the first mode of operation.

5. An electrical device as claimed in claims 3 or 4, characterized in that the device includes a control unit which controls the voltage converter circuit, the control unit being active in a STANDBY mode if the device is in the off state and the battery voltage is adequate.

6. An electrical device as claimed in claim 5, characterized in that the control unit is powered by the external power supply source or, if this source is absent and the battery voltage is adequate, by the voltage converter circuit, which is active in the UP mode.

7. An electrical device as claimed in claims 3, 4, 5 or 6, characterized in that, when thy voltage converter circuit charges the storage battery in the first mode of operation, the control unit measures the charging current and controls the voltage converter circuit on the basis of the charging current thus measured.

8. An electrical device as claimed in claims 3, 4, 5, 6 or 7, characterized in that the device further includes a motor whose motor drive voltage is supplied by an external power supply source or, if this source is absent and the battery voltage is adequate, the drive voltage is supplied by the voltage converter circuit when this operates in the second mode of operation.

9. An electrical device as claimed in claim 8, characterized in that the device includes a drive voltage turn-off which turns off the motor in the case of an excessive load during starting of the motor.

10. A shaving apparatus including a voltage converter circuit as claimed in 1 or 2 or including an electrical device as claimed in claims 3, 4, 5, 6, 7, 8 or 9.
